(19) United States
(12) Patent Application Publication
(10) Pub. No.: US 2009/0006055 A1
(43) Pub. Date: Jan. 1, 2009

(54) Automated Reduction of Biomarkers

(75) Inventors: Glenn Fung, Madison, WI (US); Renaud G. Seigneuric, Crimolois (FR); Sriram Krishnan, Exton, PA (US); R. Bharat Rao, Berwyn, PA (US); Philippe Lambin, Genappe-Bousval (BE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical solutions USA, Inc., Malvern, PA (US)

(21) Appl. No.: 12/135,313

(22) Filed: Jun. 9, 2008

Related U.S. Application Data
(63) Continuation-in-part of application No. 12/113,373, filed on May 1, 2008.
(60) Provisional application No. 60/944,231, filed on Jun. 15, 2007.

(51) Int. Cl. G06G 7/60

(52) U.S. Cl. 703/6

(57) ABSTRACT

A list of biomarkers indicative of patient outcome is reduced. A computer program is applied to a set of biomarkers indicative of a patient outcome (e.g., prognosis, diagnosis, or treatment result). The computer program models the set of biomarkers with a subset of the biomarkers. The subset is identified without labeling based on the patient outcome. Instead, biomarker scores (e.g., sequence score) are used to identify the subset of biomarkers.

### RELATED APPLICATIONS

The present patent document is a continuation-in-part of application Ser. No. 12/113,373, filed May 1, 2008 and claims the benefit of the filing date under 35 U.S.C. §119(e) of Provisional U.S. Patent Application Ser. No. 60/944,231, filed Jun. 15, 2007, which are hereby incorporated by reference.

### BACKGROUND

The present embodiments relate to reduction of biomarkers. For example, a gene signature size is reduced.

At the end of the last century, the advent of highly parallel assays led to a revolution in the biological and medical sciences. This new technology provides the possibility to monitor the behavior of tens of thousands of variables at once and has led to the birth of a new growing family of ‘-omics’ disciplines, such as genomics, transcriptomics, translatomics and metabolomics. This family is intended to describe and understand given biomarker levels.

Biology and the medical sciences have entered a new era, switching from an information-deficient situation to a point where the amount of available data is not only enormous, but also expected to keep growing larger. Highly parallel assays are used to measure many biological markers (or biomarkers) in datasets where often there are relatively few observations. Omics-related problems are thus by nature underdetermined. This so-called curse of dimensionality may lead to false conclusions or not generalizable findings by over fitting the data.

DNA microarrays are the most mature of these genomic parallelized assays. DNA microarrays have been used to better understand complex living systems. Such systems (e.g., a cell, an organ, or an entire human body) are complex because of the large number of genes involved and/or because of their time and context dependent interactions. A wide panel of interactions (e.g., a positive or negative feedback loop, or a feed-forward loop) may increase the complexity of even a simple system. In molecular medicine for example, microarrays have allowed the extraction of gene signatures for diagnosis, prognosis or therapeutic decision. However, the microarrays are often designed to detect many genes, making the microarrays expensive and leading to complexity in interpretation.

### SUMMARY

In various embodiments, systems, methods, instructions, and computer readable media are provided for automated reduction of biomarkers. A computer program is applied to a set of biomarkers indicative of a patient outcome (e.g., prognosis, diagnosis, or treatment result). The computer program models the set of biomarkers with a subset of the biomarkers. The subset is identified without labeling based on the patient outcome. Biomarker scores (e.g., sequence score) are used to identify the subset of biomarkers.

In a first aspect, a system is provided for automated reduction of biomarkers. An input is operable to receive reporter values of a plurality of gene signatures and a score for each of the gene signatures. A processor is operable to identify a reduced gene signature associated with a fewer number of reporters than a number of reporters for each of the plurality of gene signatures. The processor is operable to identify as a function of the scores and without knowledge of a final response variable for the gene signatures. A display is operable to output information related to the reduced gene signature.

In a second aspect, a computer readable storage medium has stored therein data representing instructions executable by a programmed processor for automated reduction of biomarkers. The instructions include receiving a set of gene identifiers indicative of a patient outcome, and determining a reduced set of the gene identifiers, the reduced set modeling the indicative function of the set of gene identifiers, the determination being an unsupervised process with respect to the patient outcome.

In a third aspect, a method is provided for automated reduction of biomarkers. A set of biomarkers associated with prognosis, diagnosis, or treatment is received. A computer program identifies a subset of the biomarkers as a function of reporter values for a plurality of patients. The reporter values are for the biomarkers. A microarray is generated for the subset of the biomarkers and not for at least some others of the biomarkers.

Any one or more of the aspects described above may be used alone or in combination. These and other aspects, features and advantages will become apparent from the following detailed description, which is to be read in connection with the accompanying drawings. The present invention is defined by the following claims, and nothing in this section should be taken as a limitation on those claims. Further aspects and advantages are discussed below in conjunction with the preferred embodiments and may be later claimed independently or in combination.

### BRIEF DESCRIPTION OF THE DRAWINGS

FIG. 1 is a flow chart diagram of one embodiment of a method for automated reduction of biomarkers;

FIG. 2 is a graphical representation of a number of genes in a reduced signature as a function of p-values in a ranking based reduction embodiment;

FIG. 3 is a graphical representation of Kaplan-Meyer curves for the embodiment represented in FIG. 2.

FIG. 4 is a graphical representation of a number of genes in a reduced signature as a function of p-values in a cluster based reduction embodiment;

FIG. 5 is a graphical representation of Kaplan-Meyer curves for the embodiment represented in FIG. 4.

FIG. 6 is a graphical representation of a number of genes in a reduced signature as a function of p-values in a sparse distance based reduction embodiment;

FIG. 7 is a graphical representation of Kaplan-Meyer curves for the embodiment represented in FIG. 6; and

FIG. 8 is a block diagram of one embodiment of a system for automated reduction of biomarkers.

### DESCRIPTION OF EMBODIMENTS

The list of biomarkers for a given diagnosis, prognosis or treatment outcome is reduced. A study may identify a number of gene identifiers for a given patient outcome, such as about 100. Analysis, interpretation, patenting, and/or printing of a customized array may be improved by reducing the number of biomarkers to a more manageable size, such as reducing to less than half. This reduction may be beneficial in a biological or clinical setting.

Dimensionality reduction techniques may allow analyzing, interpreting, validating and taking advantage of data. Mathematical programming-based machine learning techniques may reduce the gene signature sizes as much as possible while maintaining the key characteristics of the original signature. The signature prognostic, treatment, and diagnostic significance is maintained. Linear models may be trained using 1-norm regularization. In 1-norm regularization, a sparse solution (solutions that depend on a smaller subset of the original input variables) may be provided. Other sparse solution approaches may be used.

By downsizing the relevant data to a more manageable size, core biomarkers may be identified for creating a dedicated assay (e.g., on a customized array) for routine applications (e.g., in a clinical set up), leading to individualized medicine capabilities. The core biomarkers may be used for any purpose. Patent applications may be filed based on the core biomarkers derived from studies providing a larger set of biomarkers. The reduced signatures may reproduce qualitatively and quantitatively in a similar way as the original set of signatures.

A specific example based on a DNA microarray study providing gene signatures for hypoxia is discussed herein to aid in understanding. The machine learning reduction of biomarkers is illustrated in the field of molecular oncology with previously published gene signatures. Their reduced versions are also validated on the same clinical data set and shown to encapsulate the key features (e.g., relative score) of the original gene signatures. These gene signatures were tested on a large breast cancer data set for assessing their prognostic power by Kaplan-Meier survival, univariate, and multivariate analysis. In other examples, any list of biomarkers may be downsized in an unbiased way. The techniques presented herein may be applied to a wide range of medical applications including: diagnosing a disease, predicting the outcome of a given treatment or predicting the survival time of a particular patient. The automated biomarker reduction may be used in many circumstances, including temporal or other variation.

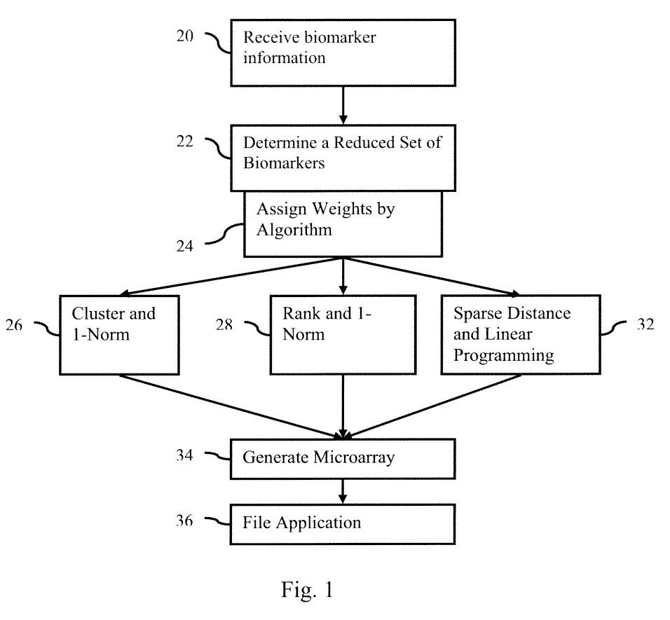

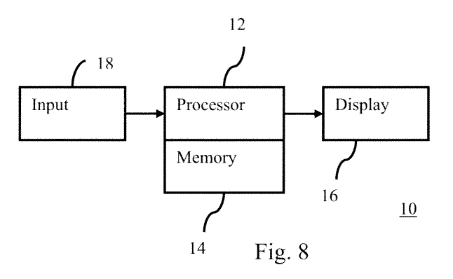

FIG. 1 shows one embodiment of a method for automated reduction of biomarkers. The method is implemented with the system of FIG. 8 or a different system. The acts are performed in the order shown or a different order. Additional, different, or fewer acts may be provided. For example, acts 26, 28, and 32 are three example approaches usable alone or together. Other approaches may be used for act 22 without performing acts 26, 28, or 32. As another example, the reduced set of biomarkers may be used for any purpose with or without also performing acts 34 and/or 36. Other approaches than assigning weights may be used, so act 24 may not be provided.

In act 20, biomarker information is received. The biomarker information may be associated with prognosis, diagnosis, or treatment. Any -omics type of biomarkers may be used. For example, a set of gene identifiers indicative of a patient outcome are received. Patient outcome includes survival, disease indicator, survival time, prognosis, treatment outcome, or diagnosis. Measurements of the biomarkers indicate patient outcome, such as a sequence of genes indicating a probable length of survival. Any level of correlation between patient outcome and the biomarkers may be provided.

The biomarker information includes a list of biomarkers. Any biomarker may be used, such as a set of genes or a gene signature. The list is for the biomarkers that may or do correlate or predict the patient outcome.

The biomarker information may include information in addition to or as an alternative to the list of biomarkers. For example, the biomarker information includes reporter values from a microarray. The reporter values are for one or more samples, such as reporter values for a list of biomarkers for a plurality of different samples or patients. Reporter values for a plurality of genes indicative of the patient outcome are received. The reporter values are for a single measurement, or may be a combination of several measurements (e.g., averaging output from reporters measuring for a same gene).

In one example embodiment, the biomarkers are for detecting early hypoxia in breast cancer. The patient outcome is the existence of early hypoxia or breast cancer, and/or survival. Hypoxia results from rapid cell growth and is generally difficult to identify. Hypoxia (i.e., lack or absence of oxygen) is a major limiting factor for radiotherapy and chemotherapy. Radiotherapy and chemotherapy may perform differently depending on the existence and/or amount of hypoxia. Identification of hypoxia may allow for better treatment or determination of survival.

Hypoxia-Inducible Factor 1 (HIF-1) is a known transcription factor that becomes stabilized and active at low oxygen levels. HIF-1 drives the expression of more than 60 target genes. Other numbers of target genes or biomarkers may be provided for HIF-1 or other factors.

The temporal gene expression under hypoxia may be measured with microarrays. The measurements indicate which genes express differently under different oxygen levels as a function of time. One example measures for several primary cell lines in vitro. Four normal cell lines are used: human coronary artery endothelial cells (ECs), smooth muscle cells (SMCs), human mammary epithelial cells (HMECs), and renal proximal tubule epithelial cells (RPTECs 1 and 2). Other cell lines and/or numbers of cell lines may be provided. Each cell line is monitored under two oxygen concentrations (less than 0.02% and 2%) using cDNA microarrays of 42,000 molecular reporters. The data set may result in 10 time series with at most six time points for each cell line. The resulting time series for hypoxia has 2.4 million gene expression measurements: 42,000 reporter values for each cell line (×4), repeated for each time (×6) and at two concentration levels (×2). Other numbers of time points, microarrays, oxygen concentrations, and/or number of time series may be used. Other studies with more or less information may be provided.

Hypoxic gene signatures that reflect differences between slow and fast hypoxia kinetic responses and their contribution to prognosis are extracted. Radiation acceptance may be different depending on the rate. Early hypoxia gene signatures may be useful prognostic tools. The HMEC series in one example test provided two time series with enough data points and differential expression between over- and under-expressed levels. For each time series (0% and 2% of oxygen), the reporters are removed if at least one time point is missing. The remaining reporters are translated into UniGene identifiers (i.e., unique gene identifier). Other removal criteria, patient outcomes of interest, number of time series, or extraction approaches may be used.

Gene expression profiling indicates the desired genes. Genes with an up-regulation or highly expressed genes in early time points are distinguished from genes exhibiting an up-regulation in later time points. In a supervised approach, a Pearson correlation provides a similarity distance. Two templates (e.g., sequences of zeros and ones) are designed to select profiles based on their time-dependent expression. The time sequences included six time points for each measurement of expression or reporter. The six time points include 0 (control), 1, 3, 6, 12 and 24 hours. The first hypoxic time points (1, 3 and 6 hours) are considered early whereas 12 and 24 hours are assigned as late time points. The template to extract early genes is 0-111-00, corresponding to binary weighting of the time sequence in order. This template attempts to identify genes active in the “1” spots and not active in the “0” spots. The first spot is a control level, so the early hypoxia spots show higher levels during early hypoxia with values similar to the control during late hypoxia. The template for late hypoxia is 0-000-11, such that control levels of expression occur during early hypoxia and high levels of expression occur during late hypoxia. Other criteria, templates, sample times, relative differences as a function of time, and/or non-binary weighting may be used.

Filtering may be applied. For example, a filtering step requires at least a two-fold induction with respect to expression under the control condition. Of the four cell lines, the filter passes information where at least two of the cell lines indicate the desired expression temporal profile. Other filtering may be used. Any level of correlation of the temporal profiles may be used to identify desired or similar expression, such as 0.6 for each filtered independently series.

The prognostic power of the derived gene signatures are statistically analyzed on a large cancer study providing microarray data. For example, the data is downloaded from http://www.ncbi.nlm.nih.gov/projects/geo/, accession number GSE3494. This dataset is referred to as the Miller dataset. This Miller dataset is completely unseen for the signature identified. None of the Miller data is used to derive the gene signature, but may be used for deriving in other embodiments. The Miller data includes a subset of 251 patients of the Uppsala cohort. For the Uppsala cohort, clinical annotations and survival time are available.

Expression data is log-transformed and multiple reporters for the same gene symbol are averaged. For each patient, a gene signature score is derived. All genes within the signature are equally weighted, but unequal weighting may be used. Depending on the score, patients were assigned to either the high or the low expressing group. Outcome (survival time) in the two groups is analyzed and compared by the Kaplan-Meier method. Log-rank tests are computed to assess survival differences between the two groups.

From univariate analyses with a level of significance of p=0.05, early hypoxia gene signatures were robustly found to be significant. P-values for difference in survival were p=0.004 (under 0%) and p=0.034 (under 2%). Late hypoxia gene signatures were robustly found to be not as significant with p-values of 0.110 and 0.842 respectively for the short versions (i.e. matching the size of their early signature counterpart). From two different statistical multivariate analysis techniques: Logistic regression and Standard Multivariate regression, the early hypoxia gene signature under 0% was found to provide more information than some clinical variables (e.g., provide more information than the status of mutations of the gene coding for the protein p53 known as ‘the guardian of the genome’).

In the hypoxia example above, a gene signature or collection of genes expressing in a desired way are identified. The desired expression pattern is temporal, so genes expressing with the desired temporal pattern are identified. The large number (e.g., 42,000 reporters in a microarray) is reduced to a much fewer number by identifying genes associated with expression variance. Statistical analysis confirms that the reduction identifies the significant genes with respect to patient outcome. This reduction is supervised with respect to patient outcome.

In alternative embodiments, other types of studies or processes may be used to identify genes with prognostic, diagnostic, or treatment indication. Other studies using the same or different approach may be used. The biomarker information received in act 20 includes the list of genes, gene signature, other biomarkers, reporter values for the biomarkers, or other information identified as having prognostic, diagnostic, treatment related or other value. This information may be obtained through studies, statistical analysis, sampling, profiling, and/or other techniques for any condition or disease. Any tissue samples, environmental manipulation (e.g., oxygen level) and/or patients may be used. Experts and/or computers may be used to select the desired biomarkers for any given purpose.

In the hypoxia example, 66 unique UniGenes are identified. More or fewer may be provided, such as thousands, hundreds, or tens. The biomarkers have potential to identify patient outcome (e.g., identify patients with poor prognosis). The identified biomarkers may be reduced in size to provide better testing. For example, a further reduced set of biomarkers is used for printing a corresponding microarray for clinical use. A small or smallest set of biomarkers that reproduces the results is desired. In the process of industrialization, the number of false positives may be decreased by using a smaller number of biomarkers. Not only does this strengthen the assay per se, but also allows printing several additional technical replicates on the available space. For example, the size of a biomarkers list is reduced by a factor of n. It is possible to multiply the number of reporters to be printed on a given customized microarray by the same quantity, n (e.g., the same reporter may be repeated multiple times). The presence of redundant probes may significantly increase the reliability of the assay. By taking the average over duplicated reporters, the measurements are more robust than measurements based on only one reporter or a fewer number of reporters.

In act 22, a reduced set of biomarkers is determined. For example, the 79 gene identifiers for hypoxia is reduced to a fewer number. Any amount of reduction may be provided, such as by half or more. A subset of biomarkers is identified. Any numbers of reductions may have been previously performed on the set of biomarkers. In act 22, the current set is further reduced. The amount of reduction may be balanced with the patient outcome predictive value, such as requiring a P-value of 0.05 or lower. Other levels of comparative significance or correlation with results may be used.

The reduction is performed by applying a computer program with a processor. Any computer program may be used. In one embodiment, a machine learning computer program, such as vector machines or linear programming, is used. User programmed or knowledge based computer programs may alternatively or additionally be used.

An unsupervised process, with respect to the patient outcome, may be used. In the reduction discussed above for identifying the 66 UniGenes, the patient outcome is used in one example to select the 66 genes from a collection of many more. In an unsupervised process, the computer program identifies a subset of the biomarkers as a function data other than or without input of the patient outcome. A label for any or the specific prognosis, diagnosis or treatment is not provided. A label for patient outcome different than the patient outcome sought may be used.

The computer program determines the reduced set based on other information than the patient outcome of interest. For example, the computer program uses reporter values for a plurality of patients. The reporter values are for the biomarkers. Sequence scores may alternatively or additionally be used. The input data may be represented as vectors. In the notation used herein, all vectors are column vectors unless transposed to a row vector by a prime superscript ′. The scalar (inner) product of two vectors x and y in the n-dimensional real space Rⁿ is denoted by x′ y and the p-norm (pε{1,2,∞}) of x is denoted by ∥x∥ₚ. For a matrix A of R^{m×n}, Aᵢ is the ith row of A which is a row vector in Rⁿ, while Aⱼ is the jth column of A. A column vector of ones of arbitrary dimension is denoted by e.

A signature S of size n is denoted as a linear function S: Rⁿ→R. The signature S is a linear mapping from an n-dimensional vector containing the n corresponding reporter values to a real number S(x), usually referred to as the signature score. The signature score is a weighted linear combination of the gene expression values, but may be defined in other manners. In one example, S is defined in the following way:

$$S ( x ) = \frac{1}{n} {\sum }_{i} {w}_{i} {x}_{i} , where {w}_{i} = 1 , ∀ i = 1 , … , n . \qquad ( 1 )$$

Given a dataset A of R^{m×n}, formed by m microarrays with n reporters each (i.e., each row corresponds to one microarray, and each column corresponds to one reporter), the components of score vector s are as follows: sᵢ=S(Aᵢ). The goal is to find an approximation S̅ to S that depends on a smaller subset of the n reporters that form the biomarker signature S. Other representations, score functions, matrix layouts, and/or definitions may be used.

The data set includes reporter values for the biomarkers received in act 20. Scores may be calculated separately or included in the received biomarker information. To determine the reduced set of biomarkers, some biomarkers are distinguished from other biomarkers. For example, the subset of biomarkers that best emulate or model the full set is identified. The unused biomarkers are deselected.

Different weights are assigned to the gene identifiers in act 24. The weights are used for selecting and deselecting biomarkers. Some of the weights are set to zero to deselect biomarkers, reducing the number of biomarkers. Other weights are set to a common value (e.g., a 1 value) or may be assigned weights that vary depending on the contribution of the biomarker to the learnt model.

The assignment of weights is a function of sequence scores associated with the gene identifiers without being a function of the patient outcome associated with the gene identifiers. In machine learning, a processor determines a weight assigned to each input. The weights are assigned to obtain the desired outcome. For the unsupervised approach, the desired outcome is a model of the behavior of the full set of biomarkers by a reduced set of biomarkers. Machine learning determines the biomarkers that contribute and/or do not contribute to the model.

The reporter dependency is strongly related to the number of zero elements (i.e., biomarkers assigned a weight of zero) of the weight vector w introduced in equation (1) since:

$${w}_{k} = 0 ⇒ S ( x ) = {\sum }_{i \neq k} {w}_{i} {x}_{i} does not depends on probe k$$

An approximation S̅ that has as few components of the vector was possible, while minimizing a given cost function that measures the goodness of fitness of s̅ with respect to s, is used.

The assignment of weights is unsupervised with respect to patient outcome. The final response variable or patient outcome (e.g., survival of the given patient, disease indicator, treatment outcome, treatment survival, final diagnosis, or other outcome) is not known or used at the moment of applying the signature reduction computer program. The sequence score function may be determined or designed based, at least in part, on the patient outcome. The assignment of weights is performed on the sequence score instead of the patient outcome.

Any computer program to reduce the number of biomarkers may be used. For example, a machine learning computer program determines weights for the various input information (reporters or biomarkers). The lowest value weights are set to zero. The machine learning may be repeated with the lesser number of biomarkers as inputs to set the weights for the biomarkers in the reduced set. In one embodiment, the machine learning includes a function for reducing one or more of the weights to a zero value. For example, a 1-norm regularization function is applied as part of the machine learning.

The machine learning uses labels based on a plurality of input samples. In one embodiment, the sequence score for the set of biomarkers for each patient is used. The input data is the reporter values for each patient. The machine learning assigns weights to the biomarkers based on the different patient data and the resulting scores associated with the patients. The weights model the full set of biomarkers such that the input values for the reduced set of biomarkers result in an output score similar to if the full set of biomarkers had been used. Any number of layers, branch structures, or weight arrangements may be used for the training.

Any mathematical-programming-based approach may be used for reducing gene signatures. In one embodiment shown at act 26, the reduced set of biomarkers is determined as a function of clustering and 1-norm regularization functions. The scores associated with the reporter values for the different patients are clustered. Any clustering may be used, such as dividing the scores into high and low clusters based on a median score or score threshold. The machine learning assigns weights to output into the appropriate cluster given fewer input reporter values. For example, clustering and a 1-norm Support vector machine (C+SVM1) are provided. Given a signature S and a vector s (sᵢ=s(Aᵢ)), an s̅ and a corresponding score vector s̅( s̅ᵢ= S̅(Aᵢ)) are generated such that similar clustering assignments are produced when clustering both vectors s and s̅ independently into two groups (high score and low score) using the same deterministic clustering computer program.

A k-means computer program, such as provided in MATLAB (MathWork Inc., Natick, Mass., USA), or other computer program may be used to generate a labeling of the training data points Aᵢ according to the clustering results (e.g., −1 if the score is assigned to the low score group and +1 if the score is assigned to the high score group). Hence, the signature approximation problem may be seen as a binary classification problem. A linear programming support vector machine (SVM) formulation, which is known to produce sparse solutions, identifies a new signature that depends on fewer reporters while reproducing the clustering assignment. The 1-norm linear programming formulation is given by:

$${min}_{w , y \geq 0 , γ} {ve}^{′} y + {‖ w ‖}_{1} \\ s . t D ( Aw - e γ ) + y \geq e \qquad ( 2 )$$

where D is a diagonal matrix with −1 or +1 in its diagonal component dᵢᵢ according to the clustering label generated for Aᵢ and ν is parameter that balances the trade-off between classification error and sparsity (i.e., amount of reduction) of the solution. The parameter ν may be obtained by a tuning procedure, such as attempting different values and identifying the one providing a more desirable model. Formulation (2) is a linear programming problem since the equation may be rewritten in the following way:

$${min}_{w , z , y \geq 0 , γ} {ve}^{′} y + {e}^{′} z \\ s . t D ( Aw - e γ ) + y \geq e \\ - z \leq w \leq z \qquad ( 3 )$$

Other equations may be used. Other clustering may be used, such as non-binary clustering.

In another embodiment shown at act 28, the reduced set of biomarkers is determined as a function of score ranking and 1-norm regularization functions. The input reporter values of each patient are ranked by corresponding score. The scores are arranged in an order, such as highest to lowest or other order. Machine learning is used to train a classifier to model behavior so that input data from a fewer number of biomarkers results in an output at the appropriate ranking. For example, a 1-norm based ranking (RSVM1) is used to learn a sparse ranking function that attempts to reproduce the rankings generated by the original signature. Given the vector s, a sparse s̅ is generated such that for the corresponding s̅ the desired order or ranking, sᵢ≦sⱼ [symbol] s̅ᵢ̅≦ ⱼ̅ is provided. For simplicity, a ranking formulation with the addition of the 1-norm regularization results in the following linear programming problem:

$${min}_{w , y \geq 0} {ve}^{′} y + {‖ w ‖}_{1} \\ s . t {A}_{i} w - {A}_{j} w + y \geq e ∀ ( i , j ) / {s}_{i} \geq {s}_{j} \\ {A}_{i} w - {A}_{j} w - y \leq - e ∀ ( i , j ) / {s}_{i} \leq {s}_{j} \qquad ( 4 )$$

This formulation is a linear programming problem by making a change of variables identical to the one shown in formulation (3). Other more complex approaches may be used. The number of constraints is quadratic in the number of training points m. A large number of comparisons are made. This is not usually a problem in gene expression problems since the number of patients available for training is often small. However, if m is large, more efficient formulations, such as learning rankings with convex hull separations, may be used. Other ranking based machine learning may be used.

In another embodiment shown at act 32, the reduced set of biomarkers is determined as a function of sparse distance learning and linear programming functions (SDLP). Differences between scores are used. The relative order rather than the complete order is used. The infinite norm of the rows/columns of a positive semidefinite mapping matrix is minimized to achieve sparseness. A relative-distance preserving sparse low-dimensional sparse mapping matrix B is learnt. The relative distance to learn is based on the scores given by the original signature or set of biomarkers. The SDLP formulation achieves sparsity by suppressing columns of the mapping matrix B. The computer program requires examples of proximity comparisons among triplets of points (e.g., 1.5, 2.5 and 7 are three points so the differences of 1.0, 5.5, and 4.5 are used). The distance or score difference between different groups of three scores is used. Two, four or other numbers of differences may be used. For example, the form of the score of point i is closer to the score of point j than the score of point k is used. The problem can be formulated in the following way:

$${min}_{B , {y}_{t} \geq 0 , γ} v {\sum }_{t} {y}_{t} + {\sum }_{d = 1}^{n} {‖ {B}_{d} ‖}_{1} s . t . \\ ∀ ( i , j , k ) ∈ T , {‖ \overline{x} i - \overline{x} j ‖}_{2}^{2} \leq {‖ \overline{x} i - \overline{x} k ‖}_{2}^{2} + {y}_{t} \qquad ( 5 )$$

where x̅ᵢ̅=Bxᵢ. After some relaxations (i.e., relaxing the resulting semidefinite requirements (semidefinite program) to a diagonal dominance constraint (set of linear constraints)), formulation (5) may be converted to a linear programming problem. The complexity of the computer program is quadratic in the number of input features, so it may have limited feasibility even where the number of features is moderate (>80). In the hypoxia example, the original signature included 198 reporters that mapped to 66 genes available in the Miller dataset array. For acts 26 and 28, all 198 reporters may be used as inputs. Since the SDLP computer program may not handle this relatively large input space efficiently, the dimensionality of the dataset may be reduced to 66 by averaging the corresponding reporter values for each available gene in the signature. Other or no reduction in dimensionality may be used. Similar reduction of input data may be used in acts 26 and 28.

The reduced set of biomarkers and the associated machine learnt weights model the indicative function of the set of gene identifiers or initial set of biomarkers input in act 20. The reduced set of biomarkers and the machine learnt weightings model the behavior of the original gene signature. For example, a univariate analysis P-value of 0.05 or less is provided for a difference between the reduced set and the full set. Other P-values may be considered sufficient.

Using the Miller data set, the performance of the three mathematical-programming-based computer programs of acts 26 (C+SVM1), 28 (RSVM1), and 32 (SDLP) are compared. The available 251 cases of the Miller data set cohort were randomly split: 30% (76 cases) where used for training and 70% (175 cases) for testing. The v parameter that controls the trade-off between sparsity and accuracy was trained by cross-validation in the training set to have a value in the set {2⁻⁷, . . . 2⁰. . . , 2⁷}. The value from this set providing sufficient P-value while maximizing the reduction in biomarkers was selected.

In one embodiment, the user may select or influence the v parameter. For example, the user indicates the number of genes in the subset. The biomarkers are reduced to provide the number of biomarkers best modeling the full set. As another example, the user selects the sufficiency or accuracy of the modeling, and the biomarkers are reduced only enough to provide the indicated sufficiency.

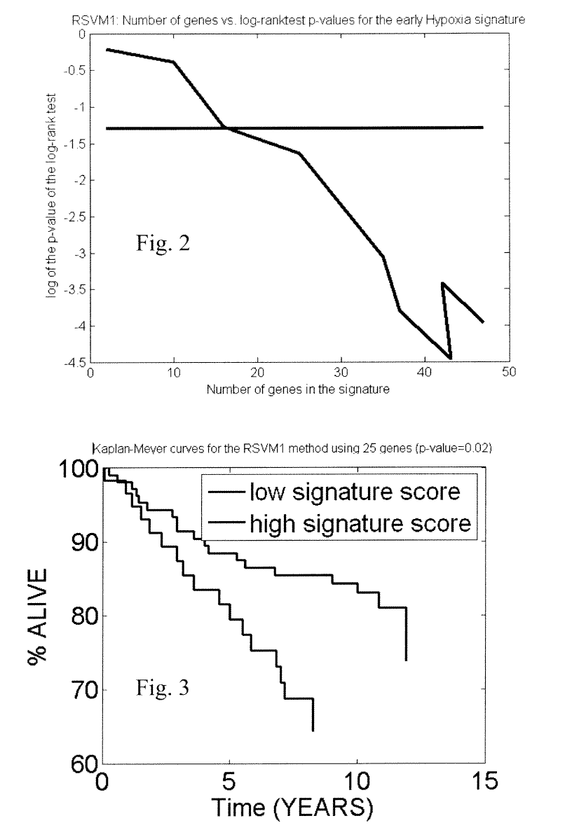

FIGS. 2, 4, and 6 show the impact of the signature reduction relative to the Kaplan-Meyer curve p-values. The Kaplan-Meyer estimator statistically estimates the survival function from lifetime data. In medical application, the Kaplan-Meyer estimate is used to measure the fraction of patients living for a certain amount of time after a first observation. The log rank test is a statistical technique to compare the survival experience of two or more populations.

The vertical axis in FIGS. 2, 4, and 6 provides the p-value on a log scale. The horizontal line in each of FIGS. 2, 4, and 6 represents P=0.05. Other thresholds of sufficiency may be used. The other line in FIGS. 2, 4, and 6 represent the P-value as a function of the number of genes remaining in the signature after reduction using the hypoxia example with the Miller dataset.

FIG. 2 shows the number of genes in the reduced signature and the corresponding signature p-values for the RSVM1 method on the Miller dataset. As shown, reduction from 66 biomarkers to 15-25 biomarkers or more provides sufficient modeling of the initial biomarkers. A reduction to 15 biomarkers reduces the initial biomarker set by about ¾.

FIG. 3 shows Kaplan-Meyer curves (p-value=0.020) for the RSVM1 method on the Miller dataset using 25 genes out of the original on the Miller dataset. The p-value of 0.020 is the p-value obtained with the 25 genes as shown in FIG. 2.

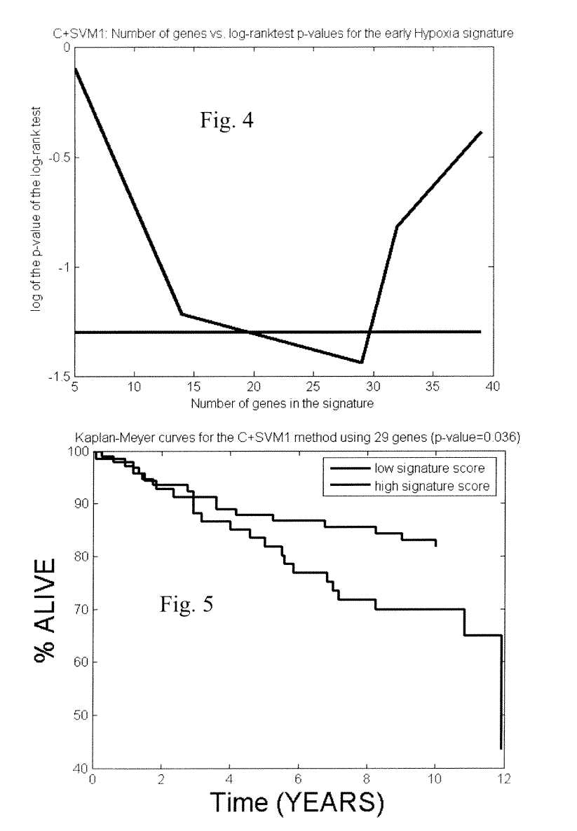

FIG. 4 shows the number of genes in the reduced signature and the corresponding signature p-values for the C+SVM1 method on the Miller dataset. As shown, reduction from 66 biomarkers to 19-29 biomarkers or more provides sufficient modeling of the initial biomarkers. A reduction to 19 biomarkers reduces the initial biomarker set by about ¾.

FIG. 5 shows Kaplan-Meyer curves (p-value=0.036) for the C+SVM1 method on the Miller dataset using 25 genes out of the original on the Miller dataset. The p-value of 0.036 is the p-value obtained with the 25 genes as shown in FIG. 4.

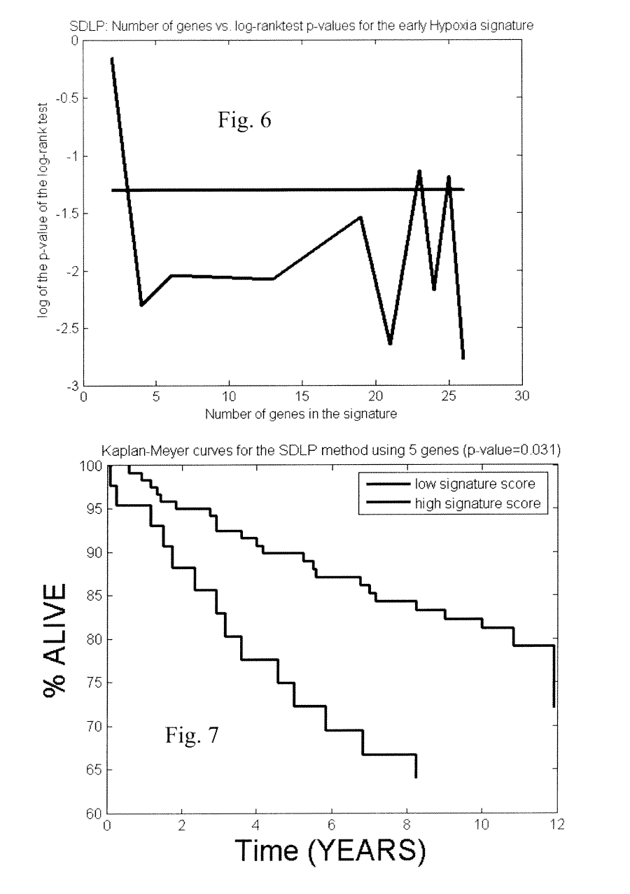

FIG. 6 shows the number of genes in the reduced signature and the corresponding signature p-values for the SDLP method on the Miller dataset. As shown, reduction from 66 biomarkers to 4-5 biomarkers or less provides sufficient modeling of the initial biomarkers. The reduced set is from 4-22 genes. Higher numbers of genes may produce less sufficient modeling. A reduction to 5 biomarkers reduces the initial biomarker set by more than 90%.

FIG. 7 shows Kaplan-Meyer curves (p-value=0.031) for the SDLP method on the Miller dataset using 5 genes out of the original on the Miller dataset. The p-value of 0.031 is the p-value obtained with the 5 genes as shown in FIG. 6.

The three applied methods reduced the size of the signature significantly, such as down to only 5 genes in the best case. The reduction is provided while maintaining a significant correlation between the original signature and the survival time of the patients in the Miller dataset. RSVM1 seems to be the more robust method. FIG. 2 suggests that there is a monotonic relation between the number of features used and significance of the reduced signature. SDLP found a good reduced signature depending on only 5 genes. Since the complexity of SDLP is quadratic in the number of the original genes, this method may be computationally expensive when the original signature has a moderate size (e.g., >80 genes).

More than one computer program may be used to reduce the number of biomarkers. For example, the RSVM1 and/or C+SVM1 computer programs are applied to an initial set of biomarkers. Another computer program, such as SDLP, is applied to the reduced set of biomarkers to provide even further reduction. In another example, expert knowledge, experimentation, or a computer program reduce the initial set. Gene ontology information may be used in the machine learning or to provide another stage of reduction in biomarkers. The relationships of different genes from an ontology may indicate biomarkers to be removed. The biomarkers may be grouped, such as by averaging or selecting a representative one of closely correlated biomarkers, for reduction. One of the unsupervised, with respect to patient outcome, computer programs described above or a different unsupervised computer program is applied for further reduction or as the initial reduction.

Data reduction for biomarkers (“omics” information) is provided. In the hypoxia example, the reduced biomarkers lists were tested and shown to still reproduce the key characteristics, for example correlation of the signature to the provided score, of the original set. The reduced list for any set of biomarkers may be used in the field of molecular medicine for individualized therapy or may be extended to any other omics fields. Other unsupervised programs may be used. The techniques are unsupervised in the sense that the outcome information (survival time in the hypoxia example) is not used to reduced the original signature. Any “black box” linear programming or machine learning operation may be used to implement the biomarker reduction.

In the hypoxia example, these techniques are implemented to reduce large supervised signatures extracted from a massive microarray data set spanning different cancer cell lines. The extraction identifies the initial set of biomarkers. Other reduction may be applied. At least one stage of reduction uses unsupervised and/or linear programming to reduce the biomarkers. The reduction results in a more manageable biomarkers lists of high clinical interest. These reduction techniques may be applied to any extracted signature sets, to any microarray data set, or to any other collection of biomarkers.

The reduced set of biomarkers is output. For example, the list is displayed. The output is to a display, to a printer, to a computer readable media (memory), or over a communications link (e.g., transfer in a network). The output may include additional information. For example, the type of computer program used, statistical analysis associated with the reduced set, data used to derive the reduced set, or other information is also output. The machine learnt matrix and/or weights may be output with or separate from the set of biomarkers.

In one embodiment, the members of the set are output to another process. For example, the set may be output for generating a microarray or test in act 34. In act 34, the reduced set of biomarkers is used in industrialization. A microarray is generated for the subset of the biomarkers and not for at least some others of the biomarkers. Reporters or probes for only the reduced set of biomarkers are integrated into the microarray. Alternatively, other reporters may be integrated, such as more reporters for the reduced set being provided but other reporters also being included. Since a reduced set of biomarkers is provided, the microarray may be cheaper to manufacture. Reporters for one or more, or all, of the biomarkers in the reduced set may be duplicated, providing more thorough testing of the significant biomarkers.

In act 36, the reduced set of biomarkers is protected. A patent application is filed to claim or cover the subset of biomarkers. For example, U.S. Published Patent Application (Ser. No. 12/113,373), the disclosure of which is incorporated herein by reference, claims gene sequences associated with the reduced sets identified in the hypoxia example. Application of the reduction to other studies, tests, conditions, diseases, or outcomes may identify different groups of gene sequences or biomarkers. These groups may be claimed in a patent application.

FIG. 8 shows a block diagram of an example system 10 for automated reduction of biomarkers. The system 10 implements the method of FIG. 1 or other methods.

The system 10 is a hardware device, but may be implemented in various forms of hardware, software, firmware, special purpose processors, or a combination thereof. Some embodiments are implemented in software as a program tangibly embodied on a program storage device. The system 10 is a computer, personal computer, server, workstation, imaging system, medical system, network processor, network, supercomputer, or other now know or later developed processing system. The system 10 includes at least one processor (hereinafter processor) 12 operatively coupled to other components. The processor 12 is implemented on a computer platform having hardware components. The other components include a memory 14, a network interface, an external storage, an input/output interface, a display 16, and a user input 18. Additional, different, or fewer components may be provided.

The computer platform also includes an operating system and microinstruction code. The various processes, methods, acts, and functions described herein may be part of the microinstruction code or part of a program (or combination thereof) which is executed via the operating system.

The input 18 is a user input, such as a mouse, keyboard, track ball, touch screen, joystick, touch pad, buttons, knobs, sliders, combinations thereof, or other now known or later developed input device. The input 18 operates as part of a user interface. For example, one or more buttons are displayed on the display 16. The input 18 is used to control a pointer for selection and activation of the functions associated with the buttons. Alternatively, hard coded or fixed buttons may be used.

The input 18 is a network interface, or external storage may operate as the input 18 operable to receive the biometric information. For example, the user selects biomarkers, sequence scores, reporter values, and/or other information by identifying a database. The data is input from the database. As another example, a stored file in a database is selected in response to user input or automatically selected by mining. In alternative embodiments, the processor 12 automatically identifies and inputs biomarker information for reducing a list of biomarkers.

The input 18 receives reporter values of a plurality of gene signatures and a score for each of the gene signatures. Alternatively, a score function is received instead of a score. The reporter values are values from an assay. The reporter values correspond to biomarkers identified for indicating a value for a final response variable (i.e., patient outcome). The reporter values and corresponding gene signatures are collected from different patients. The score is calculated from a score function derived to indicate the final response variable. The reporter values are associated with reporters correlating to the final response variable.

The processor 12 has any suitable architecture, such as a general processor, central processing unit, digital signal processor, application specific integrated circuit, field programmable gate array, digital circuit, analog circuit, combinations thereof, or any other now known or later developed device for processing data. Likewise, processing strategies may include multiprocessing, multitasking, parallel processing, and the like. A program may be uploaded to, and executed by, the processor 12. The processor 12 implements the program alone or includes multiple processors in a network or system for parallel or sequential processing.

The processor 12 performs the workflows, methods, computer programs, techniques and/or other processes described herein. For example, the processor 12 or a different processor is operable to identify a reduced gene signature associated with a fewer number of reporters than a number of reporters for input each of the plurality of gene signatures. The reduced set of genes is identified as a function of the scores and without knowledge of a final response variable for the gene signatures. For example, the final response variable is survival, disease indicator, survival time, prognosis, treatment outcome, or final diagnosis. Identification is performed without knowledge of the final response variable for the gene signatures by identifying with only the reporter values and the scores. Other information may be used.

The processor 12 implements a machine learning program or other computer program to identify an approximation to a score function used for the scores, but with the approximation having the fewer number of reporters. For example, the processor 12 identifies using a 1-norm based function and/or linear programming. The processor 12 identifies weights for the reporters using the reporter values for different patients, conditions, samples, or combinations thereof. After implementing the computer program, some of the weights are zero and some are non-zero. The non-zero weights indicate reporters included in the fewer number. Any computer program or machine training may be used. For example, the reduced set of genes or reporters is identified by clustering of the scores and 1-norm support vector machine learning. As another example, the reduced set of genes or reporters is identified by 1-norm based ranking of the scores. In another example, the reduced set of genes or reporters is identified by sparse distance learning from the scores with linear programming. The scores for the reduced set may be different than the scores for the initial set, but still be in the proper ranking, clustering, or relative difference.

The display 16 is a CRT, LCD, plasma, projector, monitor, printer, or other output device for showing data. The display 16 is operable to output information related to the reduced gene signature. For example, a list of reporters in the fewer number or reduced data set, the actual number to which the biomarkers have been reduced, or both are output. Statistical analysis of performance or sufficiency of the reduced set may be output. Data for generating a microarray may be output. A matrix or other information representing the weights or machine learnt computer program may be output. Supporting data, such as the scores, score function, input data, reduction process, or other information may be output for analysis, approval, confirmation, and/or comparison.

As an alternative or in addition to output on the display 16, the list or other information is stored, transmitted, or used in another process. For example, the processor 12 or another processor creates a model or score function to be used with the reduced list of genes. Reporter values from a microarray may be input for generating the score. The score may be correlated to the patient outcome. The further process may include classification based on the generated score or other indication of patient outcome. The display 16 may output the patient outcome for one or more patients after applying the learned model and/or model information to an assay using the reduced set of biomarkers. In another embodiment, the list is used to form or program a knowledge base for other uses.

The processor 12 operates pursuant to instructions. The instructions and/or patient records for automated reduction of biomarkers are stored in a computer readable memory 14, such as an external storage, ROM, and/or RAM. The instructions for implementing the processes, methods and/or techniques discussed herein are provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system. Because some of the constituent system components and method acts depicted in the accompanying figures may be implemented in software, the actual connections between the system components (or the process steps) may differ depending upon the manner of programming.

The same or different computer readable media may be used for the instructions, the reporter values, scores, score function, biomarkers, gene sequence, lists, or other biomarker information. The records are stored in an external storage, but may be in other memories. The external storage may be implemented using a database management system (DBMS) managed by the processor 12 and residing on a memory, such as a hard disk, RAM, or removable media. Alternatively, the storage is internal to the processor 12 (e.g. cache). The external storage may be implemented on one or more additional computer systems. For example, the external storage may include a data warehouse system residing on a separate computer system, a database system, or any other now known or later developed hospital, medical institution, medical office, testing facility, pharmacy, clinical, or other medical storage system. The external storage, an internal storage, other computer readable media, or combinations thereof store biometric data. The data may be distributed among multiple storage devices.

The reduction may be run as a service. For example, an entity is requested by the operators of a medical study or the manufacturers of microarrays to apply the biomarker reduction. The service may be performed by a third party service provider (i.e., an entity not otherwise associated with the biomarkers) or by a clinician or other group attempting to identify biomarkers for testing. Based on a per-use license, a periodically paid license, or other payment, the output list may be made available. Alternatively, the computer program for reduction is sold to a party interested in reducing a list of biomarkers.

Various improvements described herein may be used together or separately. Any form of data mining or searching may be used. Although illustrative embodiments have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A system for automated reduction of biomarkers, the system comprising:
an input operable to receive reporter values of a plurality of gene signatures and a score for each of the gene signatures;
a processor operable to identify a reduced gene signature associated with a fewer number of reporters than a number of reporters for each of the plurality of gene signatures, the processor operable to identify as a function of the scores and without knowledge of a final response variable for the gene signatures; and
a display operable to output information related to the reduced gene signature.

2. The system of claim 1 wherein the final response variable is survival, disease indicator, survival time, prognosis, treatment outcome, or final diagnosis.

3. The system of claim 1 wherein identifying without knowledge of the final response variable for the gene signatures comprises identifying with only the reporter values and the scores.

4. The system of claim 1 wherein identifying without knowledge of the final response variable for the gene signatures comprises the processor operable to identify an approximation to a score function used for the scores, the approximation having the fewer number of reporters.

5. The system of claim 1 wherein the reporter values comprise values from an assay for the final response variable, the plurality of gene signatures comprise gene signatures from different patients, and the score corresponds to a score function derived to indicate the final response variable, the reporter values being associated with reporters correlating to the final response variable.

6. The system of claim 1 wherein the information related to the reduced gene signature comprises a list of reporters in the fewer number, the fewer number, or combinations thereof.

7. The system of claim 1 wherein the processor is operable to identify using a 1-norm based function.

8. The system of claim 1 wherein the processor is operable to identify using linear programming such that the processor identifies weights for the reporters, some of the weights being zero and non-zero weights indicating reporters included in the fewer number.

9. The system of claim 1 wherein the processor is operable to identify by clustering of the scores and 1-norm support vector machine learning.

10. The system of claim 1 wherein the processor is operable to identify by 1-norm based ranking of the scores.

11. The system of claim 1 wherein the processor is operable to identify by sparse distance learning from the scores with linear programming.

12. In a computer readable storage medium having stored therein data representing instructions executable by a programmed processor for automated reduction of biomarkers, the instructions comprising:
receiving a set of gene identifiers indicative of a patient outcome; and
determining a reduced set of the gene identifiers, the reduced set modeling the indicative function of the set of gene identifiers, the determination being an unsupervised process with respect to the patient outcome.

13. The computer readable storage medium of claim 12 wherein receiving the set of gene identifiers comprises receiving reporter values for a plurality of genes indicative of the patient outcome, the patient outcome comprising survival, disease indicator, survival time, prognosis, treatment outcome, or final diagnosis.

14. The computer readable storage medium of claim 12 wherein determining comprises assigning weights to the gene identifiers, at least some of the weights being zero, the assignment being a function of sequence scores associated with the gene identifiers without being a function of the patient outcome associated with the gene identifiers.

15. The computer readable storage medium of claim 12 wherein determining comprises determining as a function of clustering and 1-norm regularization functions.

16. The computer readable storage medium of claim 12 wherein determining comprises determining as a function of score ranking and 1-norm regularization functions.

17. The computer readable storage medium of claim 12 wherein determining comprises determining as a function of sparse distance learning and linear programming functions.

18. The computer readable storage medium of claim 12 wherein a univariate analysis P-value of 0.05 or less is provided for a difference between the reduced set and the set.

19. A method for automated reduction of biomarkers, the method comprising:
receiving a set of biomarkers associated with prognosis, diagnosis, or treatment;
applying a computer program with a processor, the computer program identifying a subset of the biomarkers as a function of reporter values for a plurality of patients, the reporter values being for the biomarkers; and
generating a microarray for the subset of the biomarkers and not for at least some others of the biomarkers.

20. The method of claim 19 wherein applying comprises applying a 1-norm regularization function as a function of scores for the set of biomarkers for each patient, the computer program operable without input for a label for the prognosis, diagnosis, or treatment.

21. The method of claim 19 further comprising:
filing a patent application for the subset of biomarkers.

22. The method of claim 1 wherein the input is operable to receive a user selection of the fewer number.
